(19) United States
(12) Patent Application Publication
(10) Pub. No.: US 2026/0356005 A1
(43) Pub. Date: Nov. 12, 2026

(54) SYSTEM FOR FORMING STRUCTURAL ELEMENTS AND RELATED STRUCTURES AND METHODS THEREOF

(71) Applicant: Lambert Construction Company, Stillwater, OK (US)

(72) Inventor: Stone Pridgen Lambert, Stillwater, OK (US)

(21) Appl. No.: 19/675,287

(22) Filed: May 12, 2026

Related U.S. Application Data
(60) Provisional application No. 63/804,334, filed on May 12, 2025.

(51) Int. Cl. B28B 7/18; B28B 7/34; B33Y 80/00

(52) U.S. Cl. CPC B28B 7/183; B28B 7/346; B28B 7/348; B33Y 80/00

(57) ABSTRACT

The present disclosure pertains to a system and method for forming structural elements and related structures configured to integrate utilities within the structures. The structures may comprise a plurality of structural elements, fabricated using a mold assembly constructed via additive manufacturing techniques such as three-dimensional (3D) printing. Each structural element may include one or more conduits configured such that, when structural elements are positioned adjacent to one another, the one or more conduits of each structural element are communicatively aligned to form one or more channels within the structure. The channels may be configured to receive one or more utilities.

### CROSS REFERENCE TO RELATED APPLICATION

The present application claims priority to U.S. Provisional Application No. 63/804,334 filed on May 12, 2025, which is incorporated herein by reference.

### FIELD OF THE DISCLOSURE

The present disclosure relates generally to a system comprising modular building components; i.e., structural elements, fabricated using additive manufacturing techniques, like 3D printing. More specifically, to structural elements designed to facilitate the integration of utilities such as electrical wiring, plumbing, data cabling, or the like, within structural or non-structural walls of a structure.

### BACKGROUND

The present disclosure relates generally to construction systems and methods, and more particularly to modular forms for building structures, wherein such forms are produced via additive manufacturing techniques such as three-dimensional (3D) printing.

Conventional construction techniques have long included traditional building methods involving materials such as wood, concrete, masonry, as well as prefabricated components such as panels, blocks, or framework elements that must be manually assembled on-site. Conventional construction methods typically require multiple trades and sequential phases, including the framing of walls, installation of electrical and plumbing systems, and final finishing. This multistep process is time-consuming, labor-intensive, and susceptible to coordination delays.

One of the persistent challenges in the conventional construction of walls and/or floors is the integration of utilities —such as electrical wiring, plumbing pipes, and data cables— within the wall cavities and/or floor of the structure. In some instances, openings must be drilled or cut into studs in walls to accommodate wiring or piping. This process introduces additional labor and material costs but also risks structural compromise of code violations if not performed properly. Furthermore, retrofitting utilities into existing walls can be particularly disruptive, often requiring the removal of drywall or other finished materials.

The emergence of 3D printing technologies in construction has opened up new possibilities for building customization and efficiency. However, current implementations of 3D printed structure often face similar limitations regarding utility integration. Most 3D printed wall systems are monolithic and do not inherently support the routing or modification of utility lines. As a result, incorporating necessary infrastructure into such systems remains a significant technical hurdle, limiting broader adoption.

Modular systems—especially those that can be fabricated via 3D printing— present a promising alternative. However, to fully realize these advantages, there is a need for an improved modular system that facilitates the efficient and flexible installation of utilities while maintaining structural integrity and ease of manufacturing.

These approaches require significant labor, time, and precision alignment and they frequently depend on heavy equipment to standardize component sizes that limit design flexibility. Additionally, the need to transport prefabricated components to the construction site introduces logistical challenges and associated costs.

### SUMMARY

The present disclosure relates to a system and method for integrating utilities within a structure. The system may comprise a plurality of structural elements that are formed via a mold assembly for forming the structural element. The mold assembly comprising a first sidewall; a second sidewall positioned substantially opposite of the first sidewall; a front wall positioned substantially perpendicular to and extending between the first sidewall and the second sidewall; a rear wall positioned substantially perpendicular to and extending between the first sidewall and the second sidewall and positioned substantially opposite the front wall; a base extending between the first sidewall, the second sidewall, the front wall, and the rear wall such that a cavity is defined within the mold assembly; at least two pegs, wherein a first peg is positioned on an inner surface of the first sidewall, an inner surface of the second sidewall, an inner surface of the front wall, an inner surface of the rear wall, or a top surface of the base and the second peg is positioned on the inner surface of the first sidewall, the second sidewall, the front wall, the rear wall, or the top surface of the base; and at least one conduit extending between the pegs.

A method of forming a structural element such that the structural element has one or more conduits positioned within the structural element, comprises assembling a mold assembly, wherein the mold assembly comprises a first sidewall, a second sidewall positioned substantially opposite of the first sidewall, a front wall positioned substantially perpendicular to and extending between the first sidewall and the second sidewall, a rear wall positioned substantially perpendicular to and extending between the first sidewall and the second sidewall and positioned substantially opposite the front wall, a base extending between the first sidewall, the second sidewall, the front wall, and the rear wall, at least two pegs, wherein a first peg is positioned on an inner surface of the first sidewall, the second sidewall, the front wall, the rear wall, or a top surface of the base and a second peg is positioned on the inner surface of the first sidewall, the second sidewall, the front wall, the rear wall, or the top surface of the base; positioning material within the mold assembly; permitting the material to substantially harden in situ; and removing the first sidewall, the second sidewall, the front wall, the rear wall, and the base from around the material such that one or more conduits are positioned within the structural element, thereby defining one or more channels within the structural element.

A method of forming a structure, comprising assembling the structure from a plurality of structural elements, wherein a plurality of structural elements has one or more conduits; and positioning the structural elements adjacent to one another such that the one or more conduits of each structural element is communicatively connected to the one or more conduits of the adjacent structural element thereby forming one or more channels within the structure.

The method of the present disclosure also comprises forming a structure, wherein the structure comprises a plurality of structural elements having one or more conduits, wherein the structural elements having one or more conduits are positionable adjacent to one another such that the one or more conduits of each structural element communicatively connect with one or more conduits of an adjacent structural element thereby forming one or more channels within the structure; and a plurality of structural elements formed as a solid structural element configured to support the plurality of structural elements having one or more conduits.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 is a front perspective view of an exemplary mold assembly in accordance with the present disclosure.

FIG. 2 is a top down view of the exemplary mold assembly in accordance with the present disclosure.

FIG. 3 is cross-sectional, perspective front view of the exemplary mold assembly taken along line 3-3 of FIG. 2 in accordance with the present disclosure.

FIG. 4 is a front view of an exemplary sidewall of the mold assembly in accordance with the present disclosure.

FIG. 5 is a rear view of an exemplary sidewall of the exemplary mold assembly in accordance with the present disclosure.

FIG. 6 is a front perspective view of an exemplary structure comprising a plurality of mold assemblies in accordance with the present disclosure.

FIG. 7 is a cross-sectional front view of the exemplary structure comprising a plurality of mold assemblies taken along line 7-7 in FIG. 6 in accordance with the present disclosure.

### DETAILED DESCRIPTION

The following detailed description refers to the accompanying drawings. The same reference numbers in different drawings may identify the same or similar elements. Before explaining at least one implementation of the disclosure in detail, it is to be understood that the disclosure is not limited in its application to the details of construction, experiments, exemplary data, and/or the arrangement of the structural elements set forth in the following description or illustrated in the drawings unless otherwise noted.

The disclosure is capable of other implementations or of being practiced or carried out in various ways. It should also be understood that the phraseology and terminology employed herein for purposes of description and should not be regarded as limiting.

The mechanisms proposed in this disclosure circumvent the problems described above. The present disclosure describes a mold assembly for forming structural elements and related structures and methods thereof.

As used herein, the terms "comprises," "comprising," "includes," "including," "has," "having" or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, "or" refers to an inclusive or and not to an exclusive or. For example, a condition A or B is satisfied by anyone of the following: A is true (or present) and B is false (or not present), A is false (or not present) and B is true (or present), and both A and B are true (or present).

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

The term “communicate” as used herein will be understood to refer to the direct or indirect connection of two or more items.

In addition, use of the "a" or "an" are employed to describe elements and components of the implementations herein. This is done merely for convenience and to give a general sense of the inventive concept. This description should be read to include one or more and the singular also includes the plural unless it is obvious that it is meant otherwise.

Further, use of the term “plurality” is meant to convey “more than one” unless expressly stated to the contrary.

The use of the term "at least one" or “one or more” will be understood to include one as well as any quantity more than one. In addition, the use of the phrase "at least one of X, V, and Z" will be understood to include X alone, V alone, and Z alone, as well as any combination of X, V, and Z.

The use of ordinal number terminology (i.e., "first", "second", "third", "fourth", etc.) is solely for the purpose of differentiating between two or more items and, unless explicitly stated otherwise, is not meant to imply any sequence or order or importance to one item over another or any order of addition.

As used herein any reference to "one implementation" or "an implementation" means that a particular element, feature, structure, or characteristic described in connection with the implementation is included in at least one implementation. The appearances of the phrase "in one implementation" in various places in the specification are not necessarily all referring to the same implementation.

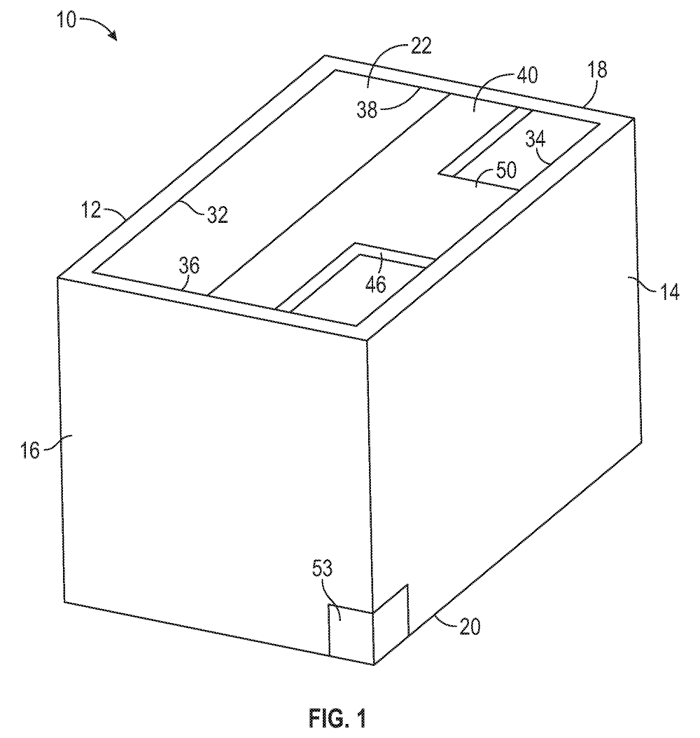

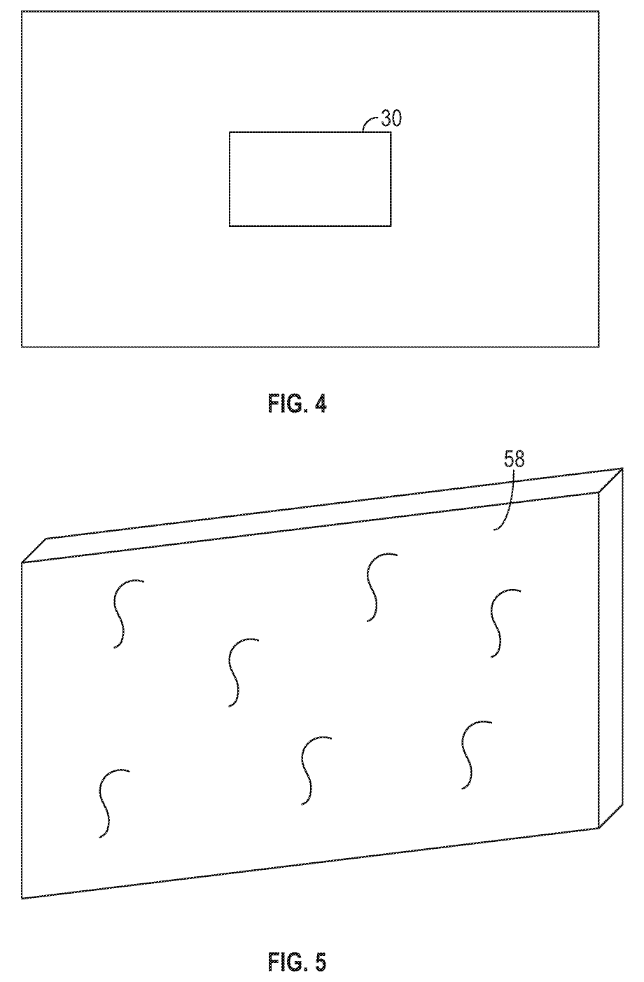

Referring now to the figures, FIG. 1 is a front, perspective view of an exemplary mold assembly 10 for forming a structural element 1, wherein the mold assembly 10 may have a first sidewall 12, a second sidewall 14 positioned substantially opposite of the first sidewall 12, a front wall 16 positioned substantially perpendicular to and extending between the first sidewall 12 and the second sidewall 14, a rear wall 18 positioned substantially perpendicular to and extending between the first sidewall 12 and the second sidewall 14 and positioned substantially opposite the front wall 16, a base 20 extending between the first sidewall 12, the second sidewall 14, the front wall 16, and the rear wall 18 such that the first sidewall 12, the second sidewall 14, the front wall 16, the rear wall 18, and the base 20 may define a cavity 22 within the mold assembly 10, at least two pegs 30 (FIG. 4 illustrates an exemplary peg), wherein a first peg (not shown) may be positioned on an inner surface 32 of the first sidewall 12, an inner surface 34 of the second sidewall 14, an inner surface 36 of the front wall 16, an inner surface 38 of the rear wall 18, or a top surface 39 of the base 20, and a second peg (not shown) that may be positioned on the inner surface 32 of the first sidewall 12, the inner surface 34 of the second sidewall 14, the inner surface 36 of the front wall 16, the inner surface 38 of the rear wall 18, or the top surface 39 of the base 20. In some non-limiting implementations, as illustrated in FIG. 5, the inner surface of at least one of the first sidewall 12, the second sidewall 14, the front wall 16, or the rear wall 18 may have one or more design configured to transfer the one or more design to an outer surface of the structural element 1 (see FIG. 5). In some non-limiting implementations, the peg 30 may be integrally formed on the one or more inner surface 32, 34, 36, 38 of the first sidewall 12, the second sidewall 14, the front wall 16, the rear wall 18, or the base 20. In some non-limiting implementations, the peg 30 may be a projection like a post, pin, or the like that may be configured to extend away from the inner surface 32 of the first sidewall 12, the inner surface 34 of the second sidewall 14, the inner surface 36 of the front wall 16, the inner surface 38 of the rear wall 18, or the top surface 39 of the base 20.

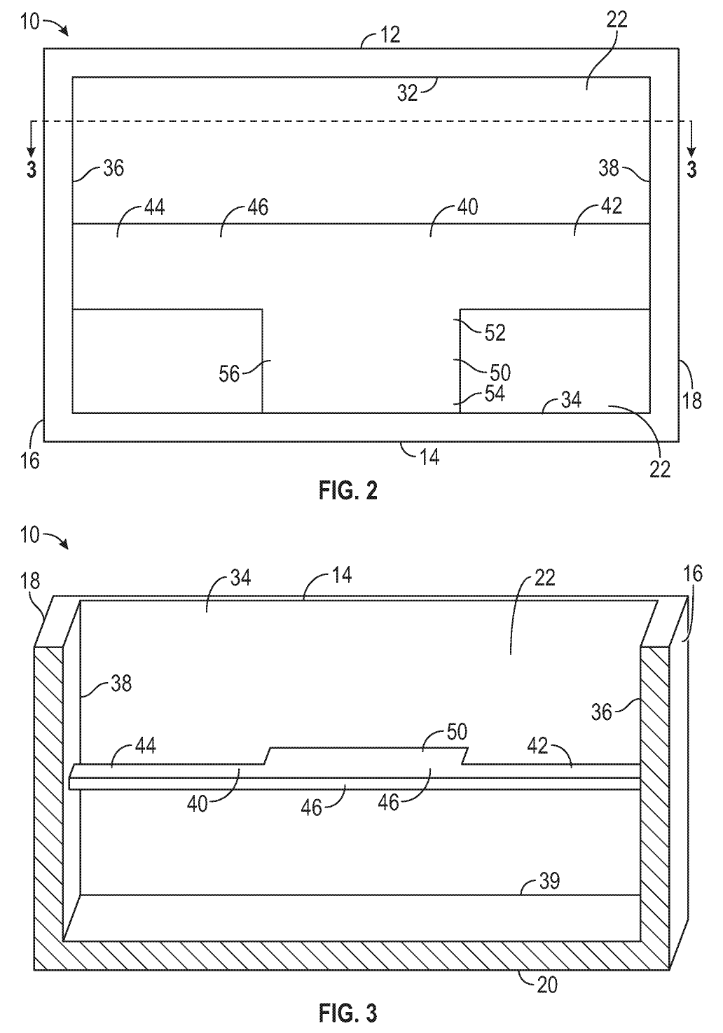

In some non-limiting implementations, as illustrated in FIGS. 1-3, the conduit 40 may have a first end 42, a second end 44, and one or more sidewall 46 extending between the first end 42 and the second end 44, and a channel 47 defined by an inner surface 48 of the one or more sidewall 46 of the conduit 40. In some non-limiting implementations, the first end 42 of the conduit 40 may be positioned on the first peg (not shown) positioned on at least one of the inner surface 32 of the first sidewall 12, the inner surface 34 of the second sidewall 14, the inner surface 36 of the front wall 16, the inner surface 38 of the rear wall, or the top surface 39 of the base 20 and the second end 44 of the conduit 40 may be positioned on a second peg (not shown) positioned on one of the inner surface 32 of the first sidewall 12, the inner surface 34 of the second sidewall 14, the inner surface 36 of the front wall 16, the inner surface 38 of the rear wall, or the top surface 39 of the base 20 such that the one or more channels 47 extend between the first end 42 to the second end 44 of the conduit 40. In some non-limiting implementations, the conduit 40 may have at least one extending member 50 extending away from the sidewall 46 of the conduit 40, wherein the extending member 50 is communicatively connected to the channel 47 of the conduit 40, wherein the extending member 50 may be configured to define at least a second channel 47 of the conduit 40. As illustrated, in FIGS. 1-3, the extending member 50 may have a first end 52 positioned on the sidewall 46 of the conduit 40, a second end 54 positioned away from the first end 52, and one or more sidewall 56 extending from the first end 52 to the second end 54, wherein the one or more sidewall 56 may have an inner surface 48 that defines a second channel 47 of the conduit 40, wherein the second channel 47 is communicatively connected to the first channel 47 of the conduit 40. In some non-limiting implementations, the second end 54 of the extending member 50 may be positioned a peg 30 positioned on the inner surface 32 of the first sidewall 12, the inner surface 34 of the second sidewall 14, the inner surface 36 of the front wall 16, the inner surface 38 of the rear wall 18, or the top surface 39 of the base 20. In some non-limiting implementations, the extending member 50 may be integrally connected or removably connected to the side wall 56 of the conduit 40. The one or more channels 47 of the conduit 40 may be configured to receive electrical wiring, plumbing, or ventilation elements.

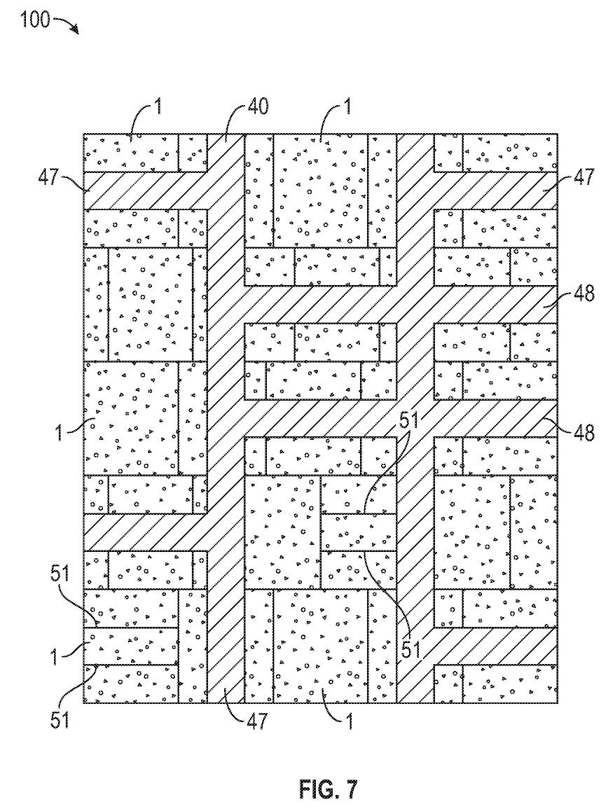

In some non-limiting implementations, as shown in FIG. 7, the mold assembly 10 may have one or more reinforcement members 51 positioned within the cavity 22 of the mold assembly 10, wherein the one or more reinforcement members 51 may extend between at least two of the first sidewall 12, the second sidewall 14, the front wall 16, the rear wall 18, and the base 20. The one or more reinforcement members 51 may be configured to enhance structural integrity of the structural element 1, thereby reducing flexural stress and improving load-bearing capacity. The one or more reinforcement members 51 may be a rod, a tension member, a bracing element, or the like. The one or more reinforcement members 51 may be rebar, a steel rod, carbon fiber rods, or may be constructed of a polymer via additive manufacturing technology.

The mold assembly 10 may be constructed, at least in part, using at least an additive manufacturing technology. By way of example, but in no way limiting, the additive manufacturing technology may be 3D printing or the like. The mold assembly 10 may be constructed, at least in part, of a polymer or the like.

In some non-limiting implementations, the one or more of the first sidewall 12, second sidewall 14, the front wall 16, the rear wall 18, or the base 20 of the mold assembly 10 may be configured to be removably connected to one another thereby enabling the mold assembly 10 to be reused. In some non-limiting implementations, the first sidewall 12, second sidewall 14, the front wall 16, the rear wall 18, or the base 20 may be removably connected to one another by one or more interlocking elements 53 (See FIG. 1). In some non-limiting implementations, the interlocking elements 53 may be integrally formed within one or more of the first sidewall 12, second sidewall 14, the front wall 16, the rear wall 18, or the base 20 via additive manufacturing. By way of example, but in no way limiting, the integrally formed interlocking elements 53 may be a tongue and groove configuration, dovetail joint configuration, slide-in track or rail configuration, interlocking tabs and slots configuration, or the like. In some non-limiting implementations, the interlocking elements 53 may be, a fastener or a fastener assembly (as shown FIG. 1). The one or more fasteners may be a screw, pin, nail, or the like. The fastener assembly may be a hinge, bracket assembly, or the like.

A method of forming a structural element 1, wherein forming the structural element 1 such that the structural element has one or more conduits 40 positioned within the structural element 1 may comprise assembling the mold assembly 10, wherein the mold assembly 10 may comprise the first sidewall 12, the second sidewall 14 positioned substantially opposite of the first sidewall 12, the front wall 16 positioned substantially perpendicular to and extending between the first sidewall 12 and the second sidewall 14, the rear wall 18 positioned substantially perpendicular to and extending between the first sidewall 12 and the second sidewall 14 and positioned substantially opposite the front wall 16, and the base 20 extending between the first sidewall 12, the second sidewall 14, the front wall 16, and the rear wall 18 thereby defining a cavity 22 within the mold assembly 10, at least two pegs 30, wherein a first peg (not shown) may be positioned on the inner surface 32 of the first sidewall 12, the inner surface 14 of the second sidewall 14, the inner surface 36 of the front wall 16, the inner surface 38 of the rear wall 18, or the top surface 39 of the base 20, and at least one conduit 40 positioned between at least the first peg 30 and the second peg 30, positioning a material within the cavity 22 of the mold assembly 10, permitting the material to substantially harden in situ; and removing the first sidewall 12, the second sidewall 14, the front wall 16, the rear wall 18, and the base 20 from around the material such that one or more conduits 40 are positioned within the structural element 1, thereby defining one or more channels 47 within the structural element 1. In some non-limiting implementations, the inner surface 32, 34, 36, 38 of at least one of the first sidewall 12, the second sidewall 14, the front wall 16, the rear wall 18, or the base 20 may have a design such that when the material positioned within the cavity 22 of the mold assembly 10 substantially hardens the design may be transferred to an exterior surface 58 of the structural element 1 (as seen in FIG. 5).

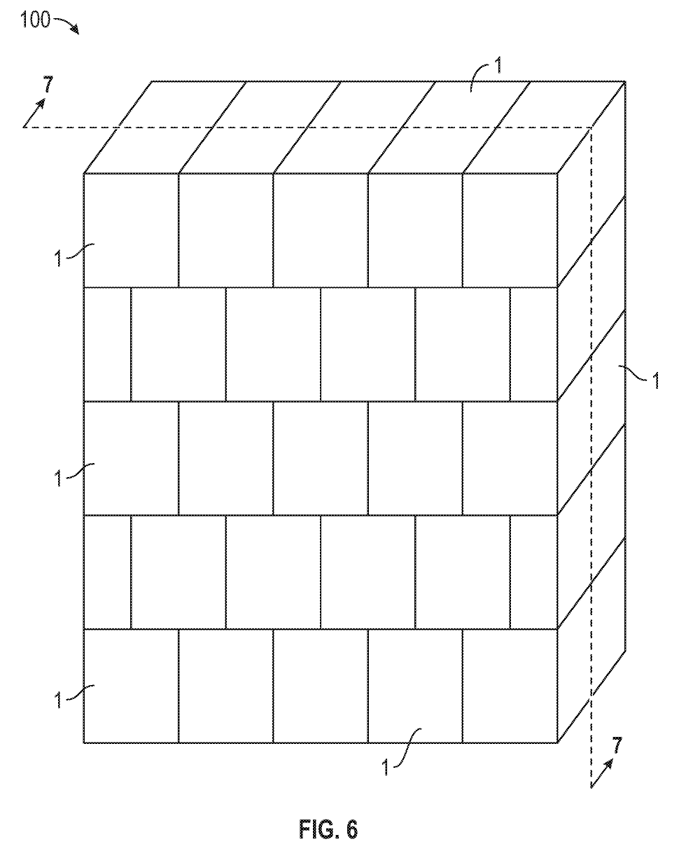

As seen in FIG. 6, a plurality of structural elements 1 may be configured to assemble a structure 100, wherein the structure comprises a plurality of structural elements 1 having one or more conduits 1. In some non-limiting implementations, the structure 100 may also comprise one or more structural elements 1 formed from the material such that one or more structural elements is a solid structural element 1; i.e., the one or more structural elements 1 may not have one or more conduit 40. The one or more solid structural elements 1 may be configured to provide support to the structure 100. In some non-limiting implementations, the one or more solid structural elements 1 may be configured to support the plurality of structural elements having one or more conduits, wherein the one or more channels of the structure are configured to receive electrical wiring, plumbing, or ventilation. In some non-limiting implementations, the one or more structural elements 1 of the structure 100 may also comprise one or more reinforcement members 51 positioned within the one or more structural elements 1.

A method of forming the structure 100, as seen in FIG. 6, comprising one or more structural element 1 assembling the structure 100 from a plurality of structural elements 1, wherein the plurality of structural elements 100 may have one or more conduits 40 and positioning the structural elements 1 adjacent to one another such that the one or more conduits 40 of each structural element 1 are communicatively connected to the one or more conduits 40 of the adjacent structural element 1 thereby forming one or more channels 47 within the structure 100 as seen in FIG. 7.

The method of forming a structure 100 may further comprise positioning electrical wiring, plumbing, or ventilation elements within the one or more channels 47 of the structure 100.

The foregoing description provides illustration and description but is not intended to be exhaustive or to limit the inventive concepts to the precise form disclosed. Modifications and variations are possible in light of the above teachings or may be acquired from practice of the methodologies set forth in the present disclosure.

Even though particular combinations of features are recited in the claims and/or disclosed in the specification, these combinations are not intended to limit the disclosure. In fact, many of these features may be combined in ways not specifically recited in the claims and/or disclosed in the specification. Although each dependent claim listed below may directly depend on only one other claim, the disclosure includes each dependent claim in combination with every other claim in the claim set.

No element, act, or instruction used in the present application should be construed as critical or essential to the invention unless explicitly described as such outside of the preferred implementation. Further, the phrase “based on” is intended to mean “based, at least in part, on” unless explicitly stated otherwise.

What is claimed is:

1. A mold assembly for forming a structural element, comprising:
a first sidewall;
a second sidewall positioned substantially opposite of the first sidewall;
a front wall positioned substantially perpendicular to and extending between the first sidewall and the second sidewall;
a rear wall positioned substantially perpendicular to and extending between the first sidewall and the second sidewall and positioned substantially opposite the front wall;
a base extending between the first sidewall, the second sidewall, the front wall, and the rear wall such that a cavity is defined within the mold assembly;
at least two pegs, wherein a first peg is positioned on an inner surface of the first sidewall, inner surface of the second sidewall, the inner surface of the front wall, the inner surface of the rear wall, or a top surface of the base and the second peg is positioned on the inner surface of the first sidewall, the second sidewall, the front wall, the rear wall, or the top surface of the base; and
at least one conduit extending between the at least two pegs.

2. The mold assembly of claim 1, wherein the conduit has a first end, a second end, and one or more sidewalls extending between the first end and second end, wherein the one or more sidewalls have an inner surface that defines a channel extending from at least the first end to the second end of the conduit, wherein the first end of the conduit is positioned on the first peg and the second end of the conduit is positioned on the second peg such that the channel extends from the first sidewall, second sidewall, front wall, rear wall, or base to the inner surface of the first sidewall, second sidewall, front wall, rear wall, or base.

3. The mold assembly of claim 2, wherein the at least one conduit has an extending member communicatively connected to the channel of the conduit, wherein the extending member is configured to define at least a second channel of the conduit.

4. The mold assembly of claim 3, wherein the mold assembly is constructed, at least in part, using at least an additive manufacturing technology.

5. The mold assembly of claim 4, wherein the mold assembly is constructed, at least in part, of a polymer.

6. The mold assembly of claim 5, wherein the inner surface of at least one of the first sidewall, the second sidewall, the front wall, the rear wall, or the base has a design.

7. The mold assembly of claim 6, wherein at least one of the two pegs is integrally formed on the inner surface of the first sidewall, the second sidewall, the front wall, the rear wall, or the base.

8. The mold assembly of claim 7, wherein the one or more of the first sidewall, the second sidewall, the front wall, the rear wall, or the base are removably connected to one another via one or more fasteners, fastener assemblies, or interlocking elements.

9. The mold assembly of claim 5, further comprising one or more reinforcement members positioned within the mold.

10. The mold assembly of claim 9, wherein the mold assembly is configured to be reused.

11. A method of forming a structural element, wherein the structural element has one or more conduits positioned within the structural element, comprising:
assembling a mold assembly, wherein the mold assembly comprises:
a first sidewall,
a second sidewall positioned substantially opposite of the first sidewall,
a front wall positioned substantially perpendicular to and extending between the first sidewall and the second sidewall,
a rear wall positioned substantially perpendicular to and extending between the first sidewall and the second sidewall and positioned substantially opposite the front wall,
a base extending between the first sidewall, the second sidewall, the front wall, and the rear wall,
at least two pegs, wherein a first peg is positioned on an inner surface of the first sidewall, the second sidewall, the front wall, the rear wall, or a top surface of the base and a second peg is positioned on the inner surface of the first sidewall, the second sidewall, the front wall, the rear wall, or the top surface of the base;
positioning material within the mold assembly;
permitting the material to substantially harden in situ; and
removing the first sidewall, the second sidewall, the front wall, the rear wall, and the base from around the material such that one or more conduits are positioned within the structural element, thereby defining one or more channels within the structural element.

12. The method of claim 11, wherein the one or more conduits have a first end, a second end, and one or more sidewalls extending between the first and second end, wherein the first end of the conduit is positioned on a first peg and the second end of the conduit is positioned on the second peg such that one or more channels extends between the first end of the conduit to the second end of the conduit.

13. The method of claim 12, wherein the at least one conduit has an extending member communicatively connected to the channel of the conduit, wherein the extending member is configured to define at least a second channel of the conduit.

14. The method of claim 13, wherein the one or more channels of the conduit are configured to receive electrical wiring, plumbing, or ventilation elements.

15. The method of claim 14, wherein the inner surface of at least one of the first sidewall, the second sidewall, the front wall, the rear wall, or the base has a design.

16. The method of claim 15, wherein the mold assembly is constructed, at least in part, using at least an additive manufacturing technology.

17. A method of forming a structure, comprising:
assembling the structure from a plurality of structural elements, wherein a plurality of structural elements has one or more conduits; and
positioning the structural elements adjacent to one another such that the one or more conduits of each structural element is communicatively connected to the one or more conduits of the adjacent structural element thereby forming one or more channels within the structure.

18. The method of claim 17, further comprising:
positioning electrical wiring, plumbing, or ventilation elements within the one or more channels of the structure.

19. The method of claim 18, wherein forming the structural element such that the structural element has one or more conduits positioned within the structural element, comprises:
assembling a mold assembly, wherein the mold assembly comprises:
a first sidewall,
a second sidewall positioned substantially opposite of the first sidewall,
a front wall positioned substantially perpendicular to and extending between the first sidewall and the second sidewall,
a rear wall positioned substantially perpendicular to and extending between the first sidewall and the second sidewall and positioned substantially opposite the front wall,
a base extending between the first sidewall, the second sidewall, the front wall, and the rear wall,
at least two pegs, wherein a first peg is positioned on an inner surface of the first sidewall, the second sidewall, the front wall, the rear wall, or a top surface of the base and a second peg is positioned on the inner surface of the first sidewall, the second sidewall, the front wall, the rear wall, or the top surface of the base;
positioning material within the mold assembly;
permitting the material to substantially harden in situ; and
removing the first sidewall, the second sidewall, the front wall, the rear wall, and the base from around the material such that one or more conduits are positioned within the structural element, thereby defining one or more channels within the structural element.

20. The method of claim 19, wherein the structure may further comprise one or more structural elements formed from a material such that the structural element is a solid structural element.

21. A structure, comprising:
a plurality of structural elements having one or more conduits, wherein the structural elements having one or more conduits are positionable adjacent to one another such that the one or more conduits of each structural element communicatively connect with one or more conduits of an adjacent structural element thereby forming one or more channels within the structure; and
a plurality of structural elements formed as a solid structural element configured to support the plurality of structural elements having one or more conduits, wherein the one or more channels of the structure are configured to receive electrical wiring, plumbing, or ventilation elements.
